(19) United States
(12) Patent Application Publication
(10) Pub. No.: US 2016/0221138 A1
(43) Pub. Date: Aug. 4, 2016

(54) FEED APPARATUS AND MACHINE TOOL

(71) Applicant: JTEKT CORPORATION, Osaka-shi (JP)

(72) Inventor: Koji TOYAMA, Hekinan-shi (JP)

(73) Assignee: JTEKT CORPORATION, Osaka-shi (JP)

(21) Appl. No.: 15/010,548

(22) Filed: Jan. 29, 2016

(30) Foreign Application Priority Data
Feb. 3, 2015 (JP) 2015-019031

(51) Int. Cl. B23Q 5/40; F16H 25/20

(52) U.S. Cl. CPC B23Q 5/40; F16H 25/20; F16H 2025/2053

(57) ABSTRACT

A feed apparatus includes a base, a moving member that is movable in a predetermined axial direction with respect to the base, a first screw shaft provided on the base so as to be parallel to the axial direction, a second screw shaft provided separately from the first screw shaft on the base so as to be parallel to the predetermined axial direction, a first motor mounted on the base to rotate the first screw shaft, a second motor mounted on the base to rotate the second screw shaft, a first nut provided on the moving member and moving in the predetermined axial direction in conjunction with rotation of the first screw shaft, and a second nut provided on the moving member and moving in the predetermined axial direction in conjunction with rotation of the second screw shaft. The first nut and the second nut are disposed at different positions in the predetermined axial direction.

### INCORPORATION BY REFERENCE

The disclosure of Japanese Patent Application No. 2015-019031 filed on Feb. 3, 2015 including the specification, drawings and abstract, is incorporated herein by reference in its entirety.

### BACKGROUND OF THE INVENTION

1. Field of the Invention

The invention relates to a feed apparatus used for a machine tool.

2. Description of Related Art

A feed apparatus for a machine tool is conventionally available which has a moving member, a screw shaft screwed in the moving member, and a motor that rotates the screw shaft as depicted in FIG. 1 of Japanese Patent Application Publication No. 2003-25178 (JP 2003-25178 A). A work and a tool used to machine the work (hereinafter referred to as simply referred to as an object as needed) are mounted on the moving member. The center of gravity of a combination of the moving member and the object is located higher than a position where the screw shaft is crewed in the moving member. Consequently, when the motor rotates the screw shaft to move the moving member in an axial direction in conjunction with rotation of the screw shaft, the moving member and the object mounted on the moving member tend to remain at the position of the center of gravity thereof. This causes the moving member to rotate about, as a center of rotation, an axis in a lateral direction obtained when a direction in which the moving member travels at the screwed position is defined as a forward direction. Accordingly, the moving member is thus pitched. When the moving body in motion is pitched, the object mounted on the moving member performs unstable behavior, and the work and the tool mounted on the moving body slightly move upward or downward. The work and the tool mounted on the moving body are displaced from regular positions thereof, which reduces machining accuracy of the machine tool.

When the screw shaft screwed in the moving member rotates, frictional heat generated at a portion of the screw shaft that is screwed in the moving member increases the temperature of the screw shaft to thermally expand the screw shaft. To suppress the thermal expansion of the screw shaft, a structure may be employed in which cooling water is allowed to flow through a cooling water passage formed along the axis of the screw shaft so as to cool the screw shaft. However, in this structure, formation of the cooling water passage leads to an increased dimension of the screw shaft in a radial direction and an increased size of the feed apparatus. Furthermore, since a mechanism that allows the cooling water to flow along the axis of the screw shaft is provided, the structure of the feed apparatus becomes complicated and manufacturing costs of the feed apparatus increases. Thus, instead of the structure in which cooling water is allowed to flow along the axis of the screw shaft, a structure is commonly used in which one end of the screw shaft is fixed in the axial direction, while the other end is enabled to move freely in the axial direction. However, in such a structure, the effect of elastic deformation of the screw shaft increasers consistently with a distance from the fixed end of the screw shaft to the position of the moving member. This reduces the rigidity of the screw shaft that is required to feed the moving member. Consequently, the amount of machining achieved by the tool machine becomes unstable, which reduces the machining accuracy of the machine tool.

A feed apparatus is available in which two motors and two screw shafts are provided in parallel in order to deal with an inertia moment in a rotating direction of the screw shaft and an inertia moment in a traveling direction of the moving member and the object. See FIG. 1 of JP 2003-25178 A. In such a feed apparatus, when the position of the center of gravity of the combination of the moving member and the object in the horizontal direction is shifted from an intermediate position between the pair of screw shafts provided in parallel toward one of the screw shafts, radial loads of the moving member and the object acting on the respective screw shafts are unbalanced. Thus, a larger radial load is imposed on the screw shaft closer to the position of the center of gravity of the combination of the moving member and the object as compared to the other screw shaft. Consequently, the life of the screw shaft closer to the position of the center of gravity is shortened.

### SUMMARY OF THE INVENTION

It is an object of the invention to provide a feed apparatus that is used for a machine tool and improves machining accuracy of the machine tool.

According to an embodiment of the present invention, a feed apparatus includes:

a base,

a moving member that is movable in a predetermined axial direction with respect to the base,

a first screw shaft provided on the base so as to be parallel to the axial direction and rotatably supported by the base,

a second screw shaft provided separately from the first screw shaft on the base so as to be parallel to the axial direction and rotatably supported by the base,

a first driving source mounted on the base to rotate the first screw shaft,

a second driving source mounted on the base to rotate the second screw shaft,

a first nut provided on the moving member and screwed over the first screw shaft to move in the axial direction in conjunction with rotation of the first screw shaft, and

a second nut provided on the moving member and screwed over the second screw shaft to move in the axial direction in conjunction with rotation of the second screw shaft.

The first nut and the second nut are disposed at different positions in the axial direction.

In this configuration, when the first screw shaft and the second screw shaft are rotated to move the moving member, the magnitude of pitching occurring in the moving member as a result of relative rotation between the first screw shaft and the first nut is different from the magnitude of pitching occurring in the moving member as a result of relative rotation between the second screw shaft and the second nut. In this case, pitching is rotation in a direction orthogonal to the axial direction and to a direction in which the moving member is disposed with respect to the base. Therefore, unlike a single nut disposed at one position in the axial direction, the first nut and the second nut disposed at different positions in the axial direction can suppress the pitching occurring in the moving member. Thus, the object such as a work and a tool mounted on the moving member can be suppressed from being displaced from the regular position. This improves the machining accuracy of the machine tool.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a top view of a feed apparatus of the present embodiment;

FIG. 2 is a side sectional view of the feed apparatus of the present embodiment, taken along line A-A in FIG. 1;

FIG. 3 is an enlarged view of a B portion in FIG. 2;

FIG. 4 is a top view of a feed apparatus of a comparative example; and

FIG. 5 is a side sectional view of the feed apparatus of the comparative example, taken along line C-C in FIG. 4.

### DETAILED DESCRIPTION OF EMBODIMENTS

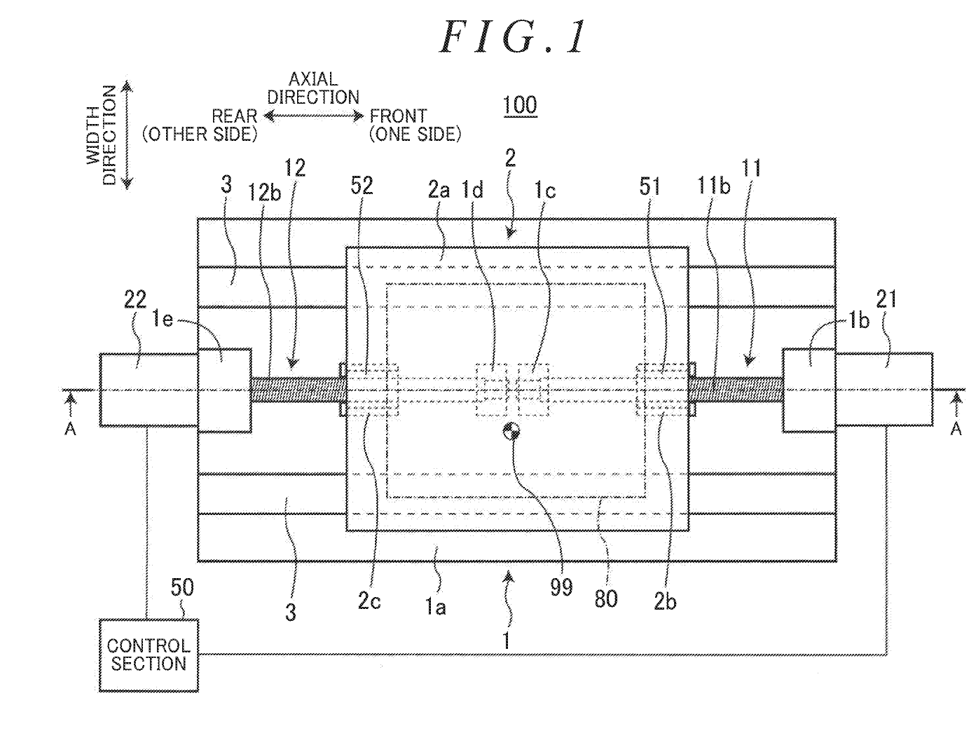

Configurations of a feed apparatus 100 and a machine tool 1000 of the present embodiment will be described based on FIGS. 1 to 3. The feed apparatus 100 is a mechanical element of the machine tool 1000 such as a lathe or a grinding machine and moves an object 80 mounted on a moving member 2. The moving member 2 is, for example, a table on which a work is mounted and which moves linearly with respect to a bed, a saddle on which a main spindle apparatus holding a tool such as an end mill is mounted and which moves linearly with respect to a column or the bed, a column on which the saddle is mounted and which moves linearly to the bed, or a wheel spindle stock table that holds a grinding wheel and moves linearly with respect to the bed. As the moving member 2, a table on which a tool as the object 80 is mounted is taken as an example.

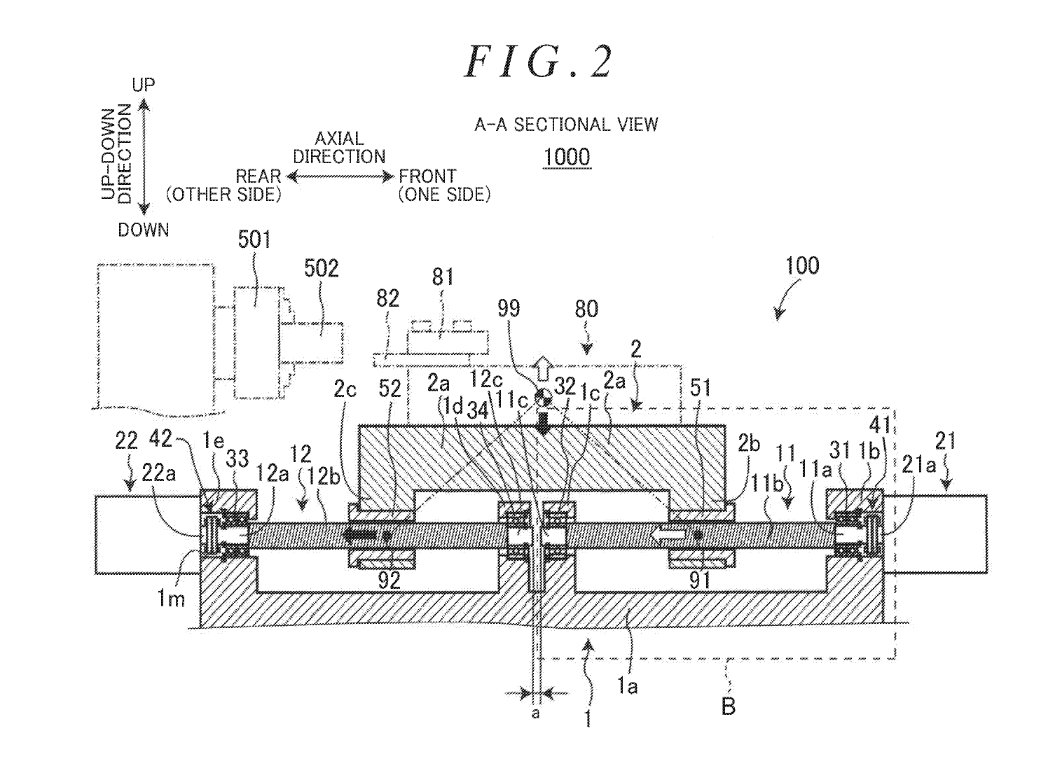

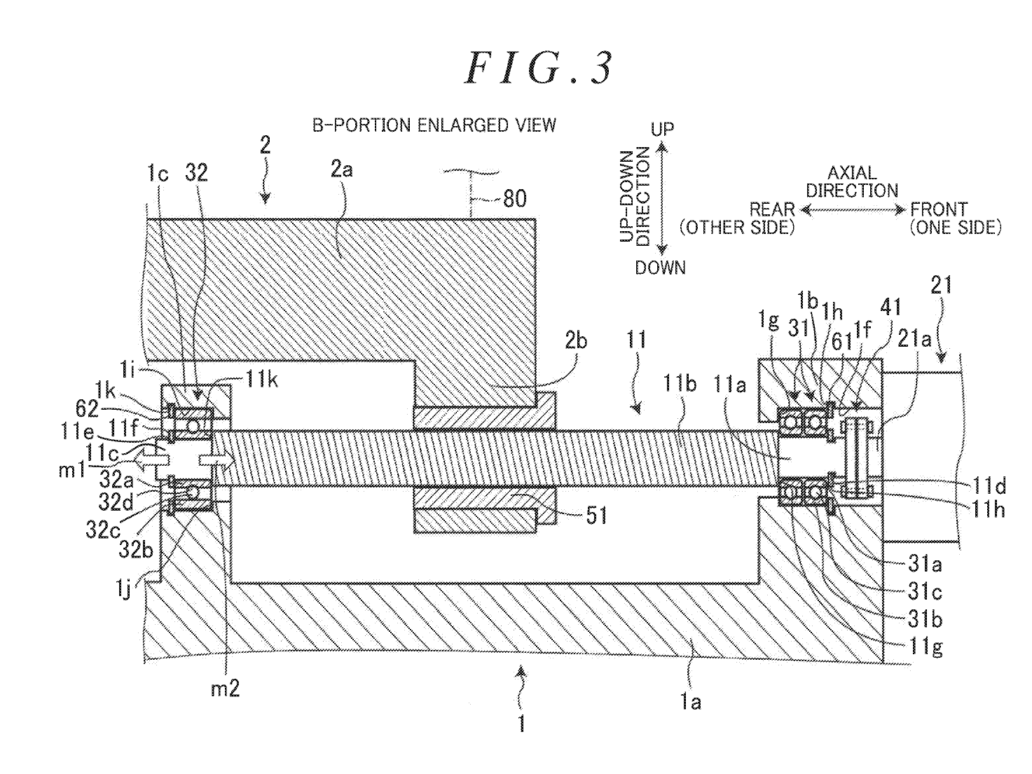

As depicted in FIGS. 1 to 3, the feed apparatus 100 has a base 1, the moving member 2, guide members 3, a first screw shaft 11, a second screw shaft 12, a first motor 21, a second motor 22, first bearings 31, a second bearing 32, third bearings 33, and a fourth bearing 34, control section 50, a first nut 51, and a second nut 52. In FIGS. 1 to 3, a lateral direction in the drawing plane is defined as an axial direction, a right side of the drawing plane is defined as the front (one side), and a left side of the drawing plane is defined as the rear (the other side). In FIG. 1, an up-down direction of the drawing plane, in other words, a direction in the drawing plane that is orthogonal to the axial direction, is defined as a width direction. In FIGS. 2 and 3, an up-down direction in the drawing sheet is defined as an up-down direction.

As depicted in FIG. 1 and FIG. 2, the base 1 includes a base portion 1a and a first support portion 1b, a second support portion 1c, a third support portion 1d, and a fourth support portion 1e all of which are integrated together. The base portion 1a is shaped like a block. The first to fourth support portions 1b to 1e are formed to protrude upward from an upper surface of the base portion 1a. The first to fourth support portions 1b to 1e are disposed from a front side (one side) toward a rear side (the other side) of the base portion 1a in the axial direction in this order. The first support portion 1b is formed at a front end (one end) of the base portion 1a. The fourth support portion 1e is formed at a rear end (the other end) of the base portion 1a. The second support portion 1c and the third support portion 1d are provided in a central portion of the base portion 1a in the axial direction so as to be adjacent each other.

As depicted in FIG. 1, a plurality of (in the present embodiment, two) guide members 3 is mounted on the base 1 such that the guide members 3 are in parallel in the width direction and extend along the axial direction. The guide members 3 are engaged with the moving member 2. The guide members 3 are, for example, linear motion guides. In this structure, the moving member 2 is mounted on an upper surface of the base 1 and mounted on the base 1 so as to be movable in the axial direction with respect to the base 1.

As depicted in FIG. 1, the first screw shaft 11 and the second screw shaft 12 are provided parallel to each other in the axial direction. The first screw shaft 11 and the second screw shaft 12 are separate from each other. Both ends of each of the first and second screw shafts 11 and 12 are rotatably supported by the base 1. An axis of the first screw shaft 11 and an axis of the second screw shaft 12 are coaxially arranged. In the present embodiment, the axis of the first screw shaft 11 and the axis of the second screw shaft 12 are provided on one straight line (a long dashed short dashed line depicted in FIG. 1) in a central portion of the base 1 in the width direction. The first screw shaft 11 is provided on a front side (one side) of the base 1. The second screw shaft 12 is provided on a rear side (the other side) of the base 1. The screw shafts 11 and 12 may be well-known ball screws or trapezoidal screws.

The first screw shaft 11 is formed of a base-end bearing portion 11a, a first threaded portion 11b, and a distal-end bearing portion 11c that are formed in this order from a base end (front end) toward a distal end (rear end) as depicted in FIG. 2 and FIG. 3. The base-end bearing portion 11a and the distal-end bearing portion 11c are shaped like columns. A groove is formed in the outer peripheral surface of the first threaded portion 11b .

The base-end bearing portion 11a, which is a base end (one end or front end) of the first screw shaft 11, is rotatably supported by a first bearing 31 fixed to the first support portion 1b. As depicted in FIG. 3, the first bearing 31 is a ball bearing and includes an inner ring 31a, an outer ring 31b disposed at an outer periphery of the inner ring 31a, and a plurality of balls 31c provided between the inner ring 31a and the outer ring 31b. The inner ring 31a and the outer ring 31b are immovable in the axial direction. In the present embodiment, two first bearings 31 are provided in parallel in the axial direction. The two first bearings 31 are mounted by being fitted into a first fixation hole if formed in the first support portion 1b so as to penetrate the first support portion 1b in the axial direction. A rear end of the outer ring 31b of the rear first bearing 31 is in contact with a step 1g formed on a rear side of the first fixation hole 1f. This inhibits the two first bearings 31 from moving rearward with respect to the first support portion 1b. A front end of the outer ring 31b of the front first bearing 31 is in contact with a C ring 61 installed in a ring groove 1h formed in the first fixation hole if over the entire a circumference of the first fixation hole 1f. This inhibits the two first bearings 31 from moving forward with respect to the first support portion 1b. In this structure, the two first bearings 31 are fixed to the first support portion 1b so as to be immovable in the axial direction.

The base-end bearing portion 11a is inserted through the inner rings 31a of the two first bearings 31. The first threaded portion 11b has an outside diameter larger than an outside diameter of the base-end bearing portion 11a. A step 11g is formed between the first threaded portion 11b and the base-end bearing portion 11a. A rear end of the inner ring 31a of the rear first bearing 31 is in contact with the step 11g to inhibit the first bearing 31 from moving rearward with respect to the first screw shaft 11. A ring groove 11d is formed in the outer peripheral surface of the base-end bearing portion 11a over the entire circumference of the base-end bearing portion 11a. A C ring 11h is installed in the ring groove 11d. The C ring 11h is in contact with a front end of the inner ring 31a of the front first bearing 31 to inhibit the first bearing 31 from moving forward with respect to the first screw shaft 11. In this structure, the base-end bearing portion 11a, which is the base end (one end) of the first screw shaft 11, is rotatably supported by the first bearings 31 so as to be immovable in the axial direction of the first screw shaft 11.

The distal-end bearing portion 11c, which is the distal end (the other end or rear end) of the first screw shaft 11, is rotatably supported by a second bearing 32 fixed to the second support portion 1c. The second bearing 32 is a ball bearing and includes an inner ring 32a, an outer ring 32b, and a plurality of balls 32c. The outer ring 32b is provided at an outer periphery of the inner ring 32a. The balls 32c are provided between the inner ring 32a and the outer ring 32b. A ball groove 32d is formed in an outer peripheral surface of the inner ring 32a over the entire circumference of the inner ring 32a, and the balls 32c engage with the ball groove 32d. On the other hand, no ball groove with which the balls 32c engage is formed in an inner peripheral surface of the outer ring 32b. Thus, the inner ring 32a and the outer ring 32b are movable in the axial direction. An embodiment is possible in which a ball groove with which the balls 32c engage is formed in the inner peripheral surface of the outer ring 32b and no ball groove is formed in the outer peripheral surface of the inner ring 32a.

The second bearing 32 is mounted by being fitted into a second fixation hole 1i formed in the second support portion 1c so as to penetrate the second support portion 1c in the axial direction. A front end of the outer ring 32b of the second bearing 32 is in abutting contact with a step 1j formed on a front side of the second fixation hole 1i. This inhibits the outer ring 32b of the second bearing 32 from moving forward with respect to the second support portion 1c. A rear end of the outer ring 32b of the second bearing 32 is in abutting contact with a C ring 62 installed in a ring groove 1k formed in the second fixation hole 1i. This inhibits the outer ring 32b of the second bearing 32 from moving rearward with respect to the second support portion 1c.

The distal-end bearing portion 11c is inserted through the inner ring 32a of the second bearing 32. The first threaded portion 11b has the outside diameter larger than an outside diameter of the distal-end bearing portion 11c. A step 11k is formed between the first threaded portion 11b and the distal-end bearing portion 11c. A front end of the inner ring 32a of the second bearing 32 is in contact with the step 11k. This inhibits the inner ring 32a of the second bearing 32 from moving forward with respect to the distal-end bearing portion 11c. A ring groove 11e is formed in the outer peripheral surface of the distal-end bearing portion 11c over the entire circumference of the distal-end bearing portion 11c. A C ring 11f is installed in the ring groove 11e. The C ring 11f is in contact with a rear end of the inner ring 32a of the second bearing 32. This inhibits the inner ring 32a of the second bearing 32 from moving rearward with respect to the distal-end bearing portion 11c. As described above, the inner ring 32a and the outer ring 32b are movable in a moving direction. Thus, the distal-end bearing portion 11c is movable in the axial direction. As a result, when the first screw shaft 11 is thermally expanded, the distal-end bearing portion 11c moves rearward (toward the distal end) (m1 in FIG. 3) to prevent deformation such as curving of the first screw shaft 11. When the first screw shaft 11 is thermally contracted, the distal -end bearing portion 11c moves forward (toward the base end) (m2 in FIG. 3) to prevent stress that acts in a direction in which the first screw shaft 11 is pulled.

The first motor 21 (first driving source) rotates the first screw shaft 11. As depicted in FIG. 2 and FIG. 3, the first motor 21 (first driving source) is attached to a front end surface of the first support portion 1b of the base 1. A rotating shaft 21a of the first motor 21 is inserted through the first fixation hole if and coupled to the base-end bearing portion 11a of the first screw shaft 11 via a first coupling member 41 such as a coupling.

As depicted in FIG. 2, the second screw shaft 12 is formed of a base-end bearing portion 12a, a second threaded portion 12b, and a distal-end bearing portion 12c that are formed in this order from a base end (rear end) toward a distal end (front end) as depicted in FIG. 2. The base-end bearing portion 12a and the distal-end bearing portion 12c are shaped like columns. A groove is formed in an outer peripheral surface of the second threaded portion 12b. The groove in the first threaded portion 11b and the groove in the second threaded portion 12b are formed in the same direction.

The base-end bearing portion 12a, which is a base end (rear end or the other end in the axial direction) of the second screw shaft 12, is rotatably supported by the third bearings 33 fixed to the fourth support portion 1e so as to be immovable in the axial direction. A structure in which the base-end bearing portion 12a is rotatably supported by the third bearings 33 fixed to the fourth support portion 1e is similar to the structure in which the base-end bearing portion 11a of the first screw shaft 11 is rotatably supported by the first bearings 31 fixed to the first support portion 1b as described above.

The distal-end bearing portion 12c, which is a distal end (front end or one end in the axial direction) of the second screw shaft 12, is rotatably supported by the fourth bearing 34 fixed to the third support portion 1d so as to be movable in the axial direction. Thus, even when the second screw shaft 12 is thermally expanded and extended in the axial direction, the distal end of the second screw shaft 12 moves forward to prevent deformation such as curving of the second screw shaft 12. When the second screw shaft 12 is thermally contracted, the distal-end bearing portion 12c moves rearward (toward the base end) to prevent stress that acts in a direction in which the second screw shaft 12 is pulled. A structure in which the distal-end bearing portion 12c is rotatably supported by the fourth bearing 34 fixed to the third support portion 1d is similar to the structure in which the distal-end bearing portion 11c of the first screw shaft 11 is rotatably supported by the second bearing 32 fixed to the second support portion 1c as described above.

The second motor 22 (second driving source) rotates the second screw shaft 12. As depicted in FIG. 2, the second motor 22 (second driving source) is attached to a rear end surface of the fourth support portion 1e of the base 1. A rotating shaft 22a of the second motor 22 is inserted through the third fixation hole 1m formed in the fourth support portion 1e and coupled to the base-end bearing portion 12a of the second screw shaft 12 via a second coupling member such as a coupling. A rotating direction of the first motor 21 is different from a rotating direction of the second motor 22. In the present embodiment, the first motor 21 and the second motor 22 are servo motors.

As depicted in FIG. 2, the rear end (first end) of the first screw shaft 11 faces the front end (second end) of the second screw shaft 12. A separation distance a (depicted in FIG. 2) between the rear end (first end) of the first screw shaft 11 and the front end (second end) of the second screw shaft 12) is set to such a dimension that the rear end (first end) of the first screw shaft 11 does not contact the front end (second end) of the second screw shaft 12 when the first screw shaft 11 and the second screw shaft 12 are maximally thermally expanded.

The moving member 2 includes a base portion 2a, a first protruding portion 2b, and a second protruding portion 2c. The base portion 2a is shaped like a block, and the object 80 such as a tool and a work (including a mounting portion used to attach the tool and the work to the base portion 2a) is mounted on the base portion 2a. In the embodiment depicted in FIG. 2, the object 80 is a tool rest 81 and a tool 82 mounted on the tool rest 81. FIG. 2 illustrates a chuck 501 forming the machine tool 1000 and a work 502 mounted on the chuck 501. The machine tool 1000 for which the feed apparatus 100 is used is a lathe.

The first protruding portion 2b extends downward from a lower portion of a front end portion (one end portion) of the base portion 2a. A first nut 51 is provided on the first protruding portion 2b. The first nut 51 is provided on a front side (one side) of the moving member 2 with respect to the center thereof in the axial direction. The first threaded portion 11b of the first screw shaft 11 is screwed in the first nut 51. In conjunction with rotation of the first screw shaft 11, the first nut 51 moves in the axial direction to move the moving member 2 in the axial direction.

The second protruding portion 2c extends downward from a lower portion of a rear end portion (the other end portion) of the base portion 2a. A second nut 52 is provided on the second protruding portion 2c. The second nut 52 is provided on a rear side (the other side) of the moving member 2 with respect to the center thereof in the axial direction. The second threaded portion 12b of the second screw shaft 12 is screwed in the second nut 52. In conjunction with rotation of the second screw shaft 12, the second nut 52 moves in the axial direction to move the moving member 2 in the axial direction.

As depicted in FIG. 1 and FIG. 2, the first nut 51 and the second nut 52 are disposed at different positions in the axial direction. When the screw shafts 11 and 12 are ball screws, a plurality of balls is provided between the threaded portions 11b and 12b of the screw shafts 11 and 12 and the respective nuts 51 and 52, and each of the nuts 51 and 52 is provided with a circulation mechanism that circulates the balls.

As depicted in FIG. 2, the first nut 51 is provided on the front side (one side) of the moving member 2 with respect to the position of the center of gravity 99 of the combination of the moving member 2 and the object 80 (hereinafter simply referred to as the position of the center of gravity 99) in the axial direction. The second nut 52 is provided on the rear side (the other side) of the moving member 2 with respect to the position of the center of gravity 99 in the axial direction. In other words, the position of the center of gravity 99 of the combination of the moving member 2 and the object 80 attached to the moving member 2 is located between a first screwed portion 91 in which the first screw shaft 11 is screwed in the first nut 51 of the moving member 2 and a second screwed portion 92 in which the second screw shaft 12 is screwed in the second nut 52 of the moving member 2.

The control section 50 supplies a driving current to the first motor 21 and the second motor 22 to rotate the first motor 21 and the second motor 22 in different directions. The first screw shaft 11 and the second screw shaft 12 rotate in the same direction. When the screw shafts 11 and 12 are rotated by the motors 21 and 22, respectively, the screw shafts 11 and 12 and the nuts 51 and 52 rotate relative to one another. The moving member 2 moves forward or rearward by a moving distance corresponding to the amounts of rotation of the screw shaft 11 and 12.

As is apparent from the above description, as depicted in FIG. 1 and FIG. 2, the feed apparatus 100 includes the base 1, the moving member 2 that is movable in the predetermined axial direction with respect to the base 1, the first screw shaft 11 provided on the base 1 parallel to the axial direction and rotatably supported by the base 1, the second screw shaft 12 provided separately from the first screw shaft 11 on the base 1 parallel to the axial direction and rotatably supported by the base 1, the first motor 21 (first driving source) mounted on the base 1 to rotate the first screw shaft 11, the second motor 22 (second driving source) mounted on the base 1 to rotate the second screw shaft 12, the first nut 51 provided on the moving member 2 and screwed over the first screw shaft 11 to move in the axial direction in conjunction with rotation of the first screw shaft 11, and the second nut 52 provided on the moving member 2 and screwed over the second screw shaft 12 to move in the axial direction in conjunction with rotation of the second screw shaft 12. The first nut 51 and the second nut 52 are disposed at different positions in the axial direction.

In this structure, when the first screw shaft 11 and the second screw shaft 12 are rotated to move the moving member 2, the magnitude of pitching occurring in the moving member 2 as a result of relative rotation between the first screw shaft 11 and the first nut 51 is different from the magnitude of pitching occurring in the moving member 2 as a result of relative rotation between the second screw shaft 12 and the second nut 52. In this case, pitching is rotation in a direction orthogonal to the axial direction and to a direction orthogonal to a direction in which the moving member 2 is disposed with respect to the base 1. Therefore, unlike a single nut disposed at one position in the axial direction, the first nut 51 and the second nut 52 disposed at different positions in the axial direction can suppress the pitching occurring in the moving member 2. Thus, the object 80 such as the work and the tool mounted on the moving member 2 can be suppressed from being displaced from a regular position. This improves the machining accuracy of the machine tool 1000.

The first nut 51 is provided on the front side (one side) of the moving member 2 with respect to the center thereof in the axial direction. The second nut 52 is provided on the rear side (the other side) of the moving member 2 with respect to the center thereof in the axial direction. This allows the pitching occurring in the moving member 2 as a result of the relative rotation between the first screw shaft 11 and the first nut 51 and the pitching occurring in the moving member 2 as a result of the relative rotation between the second screw shaft 12 and the second nut 52 to act in opposite directions. Therefore, the pitching occurring in the moving member 2 can be more reliably suppressed.

As depicted in FIG. 2, the moving member 2 is loaded on the upper surface of the base 1, and the object 80 is mounted on the moving member 2. The first nut 51 is provided on the front side (one side) of the moving member 2 with respect to the position of the center of gravity 99 of the combination of the moving member 2 and the object 80 in the axial direction. The second nut 52 is provided on the rear side (the other side) of the moving member 2 with respect to the position of the center of gravity 99 of the combination of the moving member 2 and the object 80 in the axial direction. Effects of this configuration will be described below.

When the moving member 2 moves from the front side (one side) toward the rear side (the other side) with respect to the base 1, the relative rotation between the first screw shaft 11 and the first nut 51 causes the moving member 2 to be pushed rearward (toward the other side). The center of gravity 99 is positioned rearward (on the other side) of the first nut 51. Thus, when the moving member 2 is pushed rearward (toward the other side) by the first screw shaft 11, the moving member 2 and the object 80 tend to remain at the position of the center of gravity 99 thereof. Consequently, the moving member 2 is caused to rotate clockwise about the first nut 51 (first screwed portion 91), and the moving member 2 and the object 80 is caused to move upward (a blank arrow depicted in FIG. 2).

When the moving member 2 moves from the front side (one side) toward the rear side (the other side) with respect to the base 1, the relative rotation between the second screw shaft 12 and the second nut 52 causes the moving member 2 to be pulled rearward (toward the other side). The center of gravity 99 is positioned forward (on the one side) of the second nut 52 (second screwed portion 92). Thus, when the moving member 2 is pulled rearward (toward the other side) by the second screw shaft 12, the moving member 2 and the object 80 tend to remain at the position of the center of gravity 99 thereof. Consequently, the moving member 2 is caused to rotate clockwise about the second nut 52 (second screwed portion 92), and the moving member 2 and the object 80 are caused to move downward (a filled arrow depicted in FIG. 2).

In this manner, while the moving member 2 and the object 80 are caused to move upward in conjunction with rotation of the first screw shaft 11, they are caused to move downward in conjunction with rotation of the second screw shaft 12. Thus, the pitching that causes the moving member 2 and the object 80 to move upward due to the rotation of the first screw shaft 11 and the pitching that causes the moving member 2 and the object 80 to move downward due to the rotation of the second screw shaft 12 offset each other. In contrast, when the moving member 2 moves from the rear side (the other side) toward the front side (one side), the pitching that causes the moving member 2 and the object 80 to move downward due to the rotation of the first screw shaft 11 similarly and the pitching that causes the moving member 2 and the object 80 to move upward due to the rotation of the second screw shaft 12 offset each other.

As described above, the pitching occurring in the moving member 2 and the object 80 as a result of the relative rotation between the first screw shaft 11 and the first nut 51 and the pitching occurring in the moving member 2 and the object 80 as a result of the relative rotation between the second screw shaft 12 and the second nut 52 act in opposite directions. Therefore, the pitching occurring in the moving member 2 can be reliably suppressed. As a result, the behavior of the object 80 mounted on the moving member 2 in motion is stabilized. Since the object 80 such as the work and the tool mounted on the moving member 2 is not displaced from the regular position, the machining accuracy of the machine tool 1000 is not reduced.

As depicted in FIG. 1, the axis of the first screw shaft 11 and the axis of the second screw shaft 12 are coaxially disposed. Consequently, even when the position of the center of gravity 99 of the combination of the moving member 2 and the object 80 in the width direction is shifted from the axis of the first screw shaft 11 or the second screw shaft 12 as depicted in FIG. 1, radial loads imposed on the first screw shaft 11 and the second screw shaft 12 by the moving member 2 and the object 80 are not unbalanced. Thus, the life of one of the first and second screw shafts 11 and 12 is prevented from being shortened. The radial load is load acting in the direction orthogonal to the axial direction of the first screw shaft 11 and the second screw shaft 12. In the present embodiment, the radial load is a load in the vertical direction in FIG. 2.

As depicted in FIG. 2, the first screw shaft 11 and the second screw shaft 12 each are rotatably supported at the both ends thereof by the base 1. Consequently, the both ends of each of the first and second screw shafts 11 and 12 are constrained in the radial direction orthogonal to the axial direction. Thus, as compared to a structure in which one end of each of the first and second screw shafts 11 and 12 is released in the radial direction, the present structure suppresses the first screw shaft 11 and the second screw shaft 12 from being destroyed by self-excited vibration (divergent vibration) when the first screw shaft 11 and the second screw shaft 12 move at high speed.

As depicted in FIG. 2, the first bearings 31 rotatably support one end (front end) of the two ends of the first screw shaft 11 such that the end is immovable in the axial direction. The second bearing 32 rotatably supports the other end (rear end) of the two ends of the first screw shaft 11 such that the end is movable in the axial direction. The third bearings 33 rotatably support one end (rear end) of the two ends of the second screw shaft 12 such that the end is immovable in the axial direction. The fourth bearing 34 rotatably supports the other end (front end) of the two ends of the second screw shaft 12 such that the end is movable in the axial direction.

As described above, one of the two ends of each of the screw shafts 11 and 12 is immovable in the axial direction, whereas the other of the two ends of each of the screw shafts 11 and 12 is movable in the axial direction. Consequently, when the screw shafts 11 and 12 are thermally expanded by friction between the screw shafts 11 and 12 and the nuts 51 and 52, deformation such as curving of the screw shafts 11 and 12 is prevented. Thus, when the screw shafts 11 and 12 are thermally expanded, deformation such as curving of the screw shafts 11 and 12 is prevented without the need for a mechanism that allows cooling water to flow along the axes of the screw shafts 11 and 12. This prevents increased dimensions of the screw shafts 11 and 12 in the radial direction as a result of formation of the cooling water passage, and precludes an increase in manufacturing costs of the feed apparatus 100. When the screw shafts 11 and 12 are thermally contracted, stress is prevented from being generated which acts in the direction in which the screw shafts 11 and 12 are pulled.

As depicted in FIG. 2, the first bearings 31 rotatably support the front end (one end) of the two ends of the first screw shaft 11 in the axial direction such that the end is immovable in the axial direction. The second bearing 32 rotatably supports the rear end (the other end) of the two ends of the first screw shaft 11 in the axial direction such that the end is movable in the axial direction. The third bearings 33 rotatably support the rear end (the other end) of the two ends of the second screw shaft 12 in the axial direction such that the end is immovable in the axial direction. The fourth bearing 34 rotatably supports the front end (one end) of the two ends of the second screw shaft 12 in the axial direction such that the end is movable in the axial direction. In this configuration, while the first nut 51 of the moving member 2 is close to the first bearings 31, the first bearings 31 rotatably supporting the first screw shaft 11 such that the first screw shaft 11 is immovable in the axial direction secure feeding rigidity of the first screw shaft 11. On the other hand, although the feeding rigidity of the first screw shaft 11 decreases as the first nut 51 of the moving member 2 moves away from the first bearings 31, the second nut 52 of the moving member 2 approaches the third bearings 33, which rotatably support the second screw shaft 12 such that the second screw shaft 12 is immovable in the axial direction, and thus the feeding rigidity of the second screw shaft 12 increases. In this manner, regardless of the position of the moving member 2 in the axial direction, the feeding rigidity of the combination of the first screw shaft 11 and the second screw shaft 12 is not reduced. Accordingly, the amount of machining performed by the machine tool 1000 does not become unstable, which does not reduce the machining accuracy of the machine tool 1000.

As described above, since the groove in the first threaded portion lib of the first screw shaft 11 and the groove in the second threaded portion 12b of the second screw shaft 12 are formed in the same direction, the same rolling die may be used to form the groove in the first screw shaft 11 and the groove in the second screw shaft 12. Thus, the groove in the first screw shaft 11 and the groove in the second screw shaft 12 are formed so as to have the same pitch in the axial direction. As a result, when the first screw shaft 11 and the second screw shaft 12 are rotated by the same amount, the distance that the moving member 2 fed by the first screw shaft 11 is the same as the distance that the moving member 2 is fed by the second screw shaft 12. The moving member 2 can be stably moved in the axial direction.

As depicted in FIG. 2, the distal-end bearing portion 11c (first end) of the ends of the first screw shaft 11, which is an end of the first screw shaft 11 opposite to the end thereof connected to the first motor 21 (first driving source), faces the distal-end bearing portion 12c (second end) of the ends of the second screw shaft 12, which is an end of the second screw shaft 12 opposite to the end thereof connected to the second motor 22 (second driving source). The separation distance a between the distal-end bearing portion 11c (first end) and the distal-end bearing portion 12c (second end) is set to such a dimension that the distal-end bearing portion 11c (first end) does not contact the distal-end bearing portion 12c (second end) when the first screw shaft 11 and the second screw shaft 12 are maximally thermally expanded. Thus, even when the screw shafts 11 and 12 rotate and are thermally expanded by frictional heat generated between the screw shafts 11 and 12 and the nuts 51 and 52, the distal-end bearing portion 11c (first end) does not contact the distal-end bearing portion 12c (second end). This prevents the screw shafts 11 and 12 from being curved by the contact between the distal-end bearing portion 11c (first end) and the distal-end bearing portion 12c (second end), and thus the machining accuracy of the machine tool 100 is not reduced. The maximum amounts of thermal expansion of the first screw shaft 11 and the second screw shaft 12 are set as needed based on the maximum amount of change in temperature of the feed apparatus 100, which is estimated as specifications when the feed apparatus 100 is designed, simulation results for the amount of thermal expansion resulting from a change in the temperature of the feed apparatus 100, actually measured values of the amount of thermal expansion resulting from a change in the temperature of the feed apparatus 100, or the like.

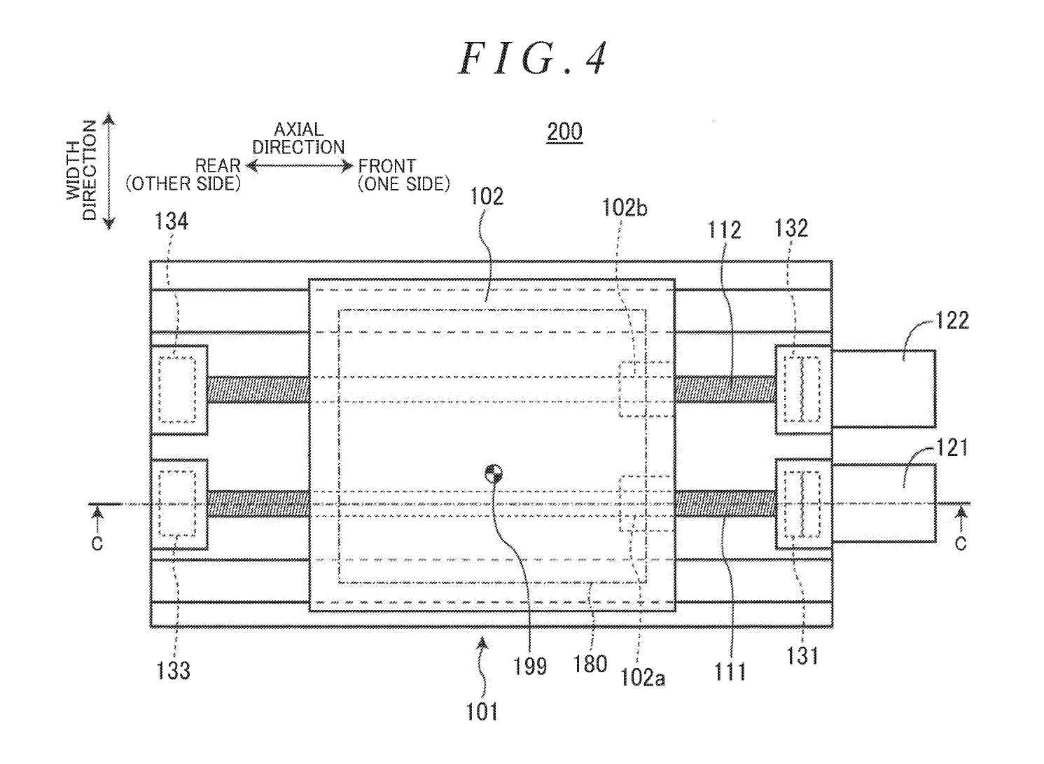

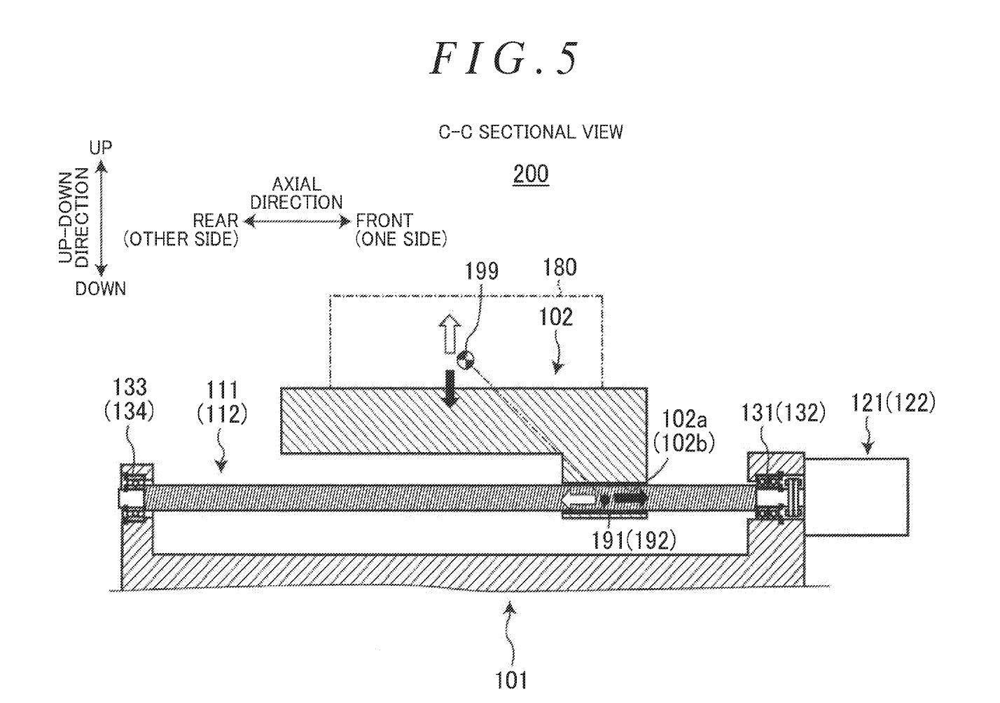

A feed apparatus 200 in a comparative example will be described below using FIG. 4 and FIG. 5. As depicted in FIG. 4 and FIG. 5, in the feed apparatus 200 in the comparative example, a base 101 is provided with two screw shafts 111 and 112 and two motors 121 and 122 that rotate the screw shafts 111 and 112. The screw shafts 111 and 112 are screwed in threaded holes 102a and 102b, respectively, formed at the same position in the axial direction. In an example illustrated in FIG. 5, the position of the center of gravity 199 of a combination of a moving member 102 and an object 180 mounted on the moving member 102 (hereinafter referred to as the position of the center of gravity 199) is located on the rear side of screwed portions 191 and 192 between the moving member 102 and the screw shafts 111 and 112.

In the feed apparatus 200 configured as described above, when the screw shafts 111 and 112 rotate, the moving member 102 behaves as follows. When the moving member 102 moves from the front side toward the rear side with respect to the base 101, the moving member 102 is pushed rearward by the screw shafts 111 and 112. Since the moving member 102 and the object 180 tend to remain at the position of the center of gravity 199 thereof, the moving member 102 will rotate clockwise about screwed portions 191 and 192 between the moving member 102 and the screw shafts 111 and 112 and the object 180 mounted on the moving member 102 will move upward (a blank arrow depicted in FIG. 5). On the other hand, when the moving member 102 moves from the rear side toward the front side with respect to the base 101, the moving member 102 is pulled forward by the screw shafts 111 and 112. Since the moving member 102 and the object 180 tend to remain at the position of the center of gravity 199 thereof, the moving member 102 will rotate counterclockwise about the screwed portions 191 and 192 and the object 180 mounted on the moving member 102 will move downward (a filled arrow depicted in FIG. 5).

When the moving member 102 is caused to rotate using the screwed portions 191 and 192 as centers of rotation as described above, a work and a tool that are the object 180 mounted on the moving member 102 in motion exhibit unstable behavior. The work and the tool that are the object 180 mounted on the moving member 102 slightly move upward or downward and are displaced from regular positions thereof. Thus, the machining accuracy of the machine tool including the feed apparatus 200 is reduced.

As depicted in FIG. 4 and FIG. 5, in the feed apparatus 200 of the comparative example, one end of each of the screw shafts 111 and 112 is rotatably supported by corresponding bearings 131 and 132 provided on the base 101 so that the screw shafts 111 and 112 are immovable in the axial direction. The other end of each of the screw shafts 111 and 112 is rotatably supported by a corresponding one of bearings 133 and 134 provided on the base 101 so that the screw shafts 111 and 112 are movable in the axial direction. In the feed apparatus 200, the effect of elastic deformation of the screw shafts 111 and 112 increasers as threaded holes 102a and 102b in the moving member 102 moves away from the bearings 131 and 132 provided on the base 101 so that the screw shafts 111 and 112 are immovable in the axial direction to. This reduces the feeding rigidity of the screw shafts 111 and 112.

As depicted in FIG. 4, when the position of the center of gravity 199, in the width direction, of the combination of the moving member 102 and the object 180 mounted on the moving member 102 is shifted from an intermediate position between the pair of screw shafts 111 and 112 provided in parallel toward the screw shaft 111 on one side, radial loads acting on the respective screw shafts 111 and 112 are unbalanced. Thus, a heavier radial load is imposed on the screw shaft 111, which is closer to the position of the center of gravity 199, than on the other screw shaft 112. Consequently, the life of the screw shaft 111, which is closer to the position of the center of gravity 199, is shortened.

In the above-described embodiment, the first screw shaft 11 and the second screw shaft 12 are provided on a straight line as depicted in FIG. 1. However, an embodiment is possible in which the first screw shaft 11 and the second screw shaft 12 are not provided on a straight line but are offset from each other in the width direction. Even in this embodiment, the position of the center of gravity 99 of the combination of the moving member 2 (moving member) and the object 80 mounted on the moving member 2 is located between the first screwed portion 91 and the second screwed portion 92. Thus, as described above, a force exerted by the first screw shaft 11 to move the object 80 upward or downward and a force exerted by the second screw shaft 12 to move the object 80 downward or upward offset each other. The object 80 mounted on the moving member 2 thus does not move in the up-down direction. Accordingly, the machining accuracy of the machine tool 1000 is not reduced.

An embodiment having configurations (1) to (4) is also possible instead of the above-described embodiment.

(1) The first bearings 31 rotatably support the rear end (the other end) of the two ends of the first screw shaft 11 in the axial direction such that the end is immovable in the axial direction.

(2) The second bearing 32 rotatably supports the front end (one end) of the two ends of the first screw shaft 11 in the axial direction such that the end is movable in the axial direction.

(3) The third bearings 33 rotatably support the front end (one end) of the two ends of the second screw shaft 12 in the axial direction such that the end is immovable in the axial direction.

(4) The fourth bearing 34rotatably supports the rear end (the other end) of the two ends of the second screw shaft 12 in the axial direction such that the end is movable in the axial direction.

Even in such an embodiment, regardless of the position of the moving member 2 in the axial direction, the feeding rigidity of the combination of the first screw shaft 11 and the second screw shaft 12 does not decrease. Furthermore, the amount of machining performed by the machine tool 1000 does not become unstable, which does not reduce the machining accuracy of the machine tool 1000.

An embodiment having configurations (5) to (8) is also possible instead of the above-described embodiment.

(5) The first bearings 31 rotatably support the front end (one end) of the two ends of the first screw shaft 11 in the axial direction such that the end is immovable in the axial direction.

(6) The second bearing 32 rotatably supports the rear end (the other end) of the two ends of the first screw shaft 11 in the axial direction such that the end is movable in the axial direction.

(7) The third bearings 33rotatably support the front end (one end) of the two ends of the second screw shaft 12 in the axial direction such that the end is immovable in the axial direction.

(8) The fourth bearing 34 rotatably supports the rear end (the other end) of the two ends of the second screw shaft 12 in the axial direction such that the end is movable in the axial direction.

An embodiment having configurations (9) to (12) is also possible instead of the above-described embodiment.

(9) The first bearings 31 rotatably support the rear end (the other end) of the two ends of the first screw shaft 11 in the axial direction such that the end is immovable in the axial direction.

(10) The second bearing 32 rotatably supports the front end (one end) of the two ends of the first screw shaft 11 in the axial direction such that the end is movable in the axial direction.

(11) The third bearings 33 rotatably support the rear end (the other end) of the two ends of the second screw shaft 12 in the axial direction such that the end is immovable in the axial direction.

(12) The fourth bearing 34 rotatably supports the front end (one end) of the two ends of the second screw shaft 12 in the axial direction such that the end is movable in the axial direction.

Even in the embodiment having the configurations (5) to (8) or the embodiment having the configurations (9) to (12), the force exerted by the first screw shaft 11 to move the object 80 upward or downward and the force exerted by the second screw shaft 12 to move the object 80 downward or upward offset each other. The object 80 mounted on the moving member 2 thus does not move in the up-down direction. Accordingly, the machining accuracy of the machine tool 1000 is not reduced.

In the above-described embodiment, the groove in the first threaded portion 11b of the first screw shaft 11 and the groove in the second threaded portion 12b of the second screw shaft 12 are formed in the same direction. However, an embodiment is possible in which the groove in the first threaded portion 11b of the first screw shaft 11 and the groove in the second threaded portion 12b of the second screw shaft 12 are formed in different directions.

In the above-described embodiment, the first motor 21 is provided on the first support portion 1b formed on the front side (one side) of the base 1, and the second motor 22 is provided on the fourth support portion 1e formed on the rear side (the other side) of the base 1. However, an embodiment is possible in which the first motor 21 is provided on the second support portion 1c formed in the central portion of the base 1 and the second motor 22 is provided on the third support portion 1d formed in the central portion of the base 1. In this embodiment, the first motor 21 and the second motor 22 rotate in the opposite directions.

An embodiment is possible in which the first motor 21 is provided on the first support portion 1b formed on the front side (one side) of the base 1 and the second motor 22 is provided on the third support portion 1d formed in the central portion of the base 1. Alternatively, an embodiment is possible in which the first motor 21 is provided on the second support portion 1c formed in the central portion of the base 1 and the second motor 22 is provided on the fourth support portion 1e formed on the rear side (the other side) of the base 1. In these embodiments, the first motor 21 and the second motor 22 rotate in the same direction.

In the above-described embodiment, the object 80 is mounted on the moving member 2. However, an embodiment is possible in which the object 80 is not mounted on the moving member 2. In this embodiment, the first nut 51 is provided on the front side (one side) of the moving member 2 in the axial direction with respect to the position of the center of gravity of the moving member 2. The second nut 52 is provided on the rear side (the other side) of the moving member 2 in the axial direction with respect to the position of the center of gravity of the moving member 2. Such a configuration allows the pitching occurring in the moving member 2 as a result of the relative rotation between the first screw shaft 11 and the first nut 51 and the pitching occurring in the moving member 2 as a result of the relative rotation between the second screw shaft 12 and the second nut 52 to act in the opposite directions. Therefore, the pitching occurring in the moving member 2 can be reliably suppressed.

In the above-described embodiment, the first nut 51 and the second nut 52 are provided on the moving member 2. However, an embodiment is also possible in which a first nut screwed over the first screw shaft 11 is formed in the moving member 2 and a second nut screwed over the second screw shaft 12 is formed in the moving member 2.

An embodiment is also possible in which a driving source such as an air actuator or an engine is used instead of the motors 21 and 22 that rotate the screw shafts 11 and 12.

What is claimed is:

1. A feed apparatus comprising:
a base,
a moving member that is movable in a predetermined axial direction with respect to the base,
a first screw shaft provided on the base so as to be parallel to the axial direction and rotatably supported by the base,
a second screw shaft provided separately from the first screw shaft on the base so as to be parallel to the axial direction and rotatably supported by the base,
a first driving source mounted on the base to rotate the first screw shaft,
a second driving source mounted on the base to rotate the second screw shaft,
a first nut provided on the moving member and screwed over the first screw shaft to move in the axial direction in conjunction with rotation of the first screw shaft, and
a second nut provided on the moving member and screwed over the second screw shaft to move in the axial direction in conjunction with rotation of the second screw shaft; wherein
the first nut and the second nut are disposed at different positions in the axial direction.

2. The feed apparatus according to claim 1, wherein
the first nut is provided on one side of the moving member with respect to a center of the moving member in the axial direction, and
the second nut is provided on the other side of the moving member with respect to the center of the moving member in the axial direction

3. The feed apparatus according to claim 1, wherein
the moving member is loaded on an upper surface of the base,
the first nut is provided on one side of the moving member with respect to a position of a center of gravity of the moving member in the axial direction, and
the second nut is provided on the other side of the moving member with respect to the position of the center of gravity of the moving member in the axial direction.

4. The feed apparatus according to claim 1, wherein
the moving member is loaded on an upper surface of the base, and an object is mounted on the moving member,
the first nut is provided on one side of the moving member with respect to a position of a center of gravity of a combination of the moving member and the object in the axial direction, and
the second nut is provided on the other side of the moving member with respect to the position of the center of gravity of the combination in the axial direction

5. The feed apparatus according to claim 1, wherein
an axis of the first screw shaft and an axis of the second screw shaft are coaxially disposed.

6. The feed apparatus according to claim 1, wherein
the first screw shaft and the second screw shaft are each rotatably supported at both ends thereof by the base.

7. The feed apparatus according to claim 6, wherein
one end of the first screw shaft in the axial direction is supported by the base so as to be immovable in the axial direction and to be rotatable,
the other end of the first screw shaft in the axial direction is supported by the base so as to be movable in the axial direction and to be rotatable,
one end of the second screw shaft in the axial direction is supported by the base so as to be movable in the axial direction and to be rotatable, and
the other end of the second screw shaft in the axial direction is supported by the base so as to be immovable in the axial direction and to be rotatable.

8. The feed apparatus according to claim 1, wherein
the first screw shaft and the second screw shaft have respective grooves formed in an identical direction.

9. A machine tool comprising the feed apparatus as claimed in claim 1.
